(19) United States
(12) Patent Application Publication
(10) Pub. No.: US 2007/0181697 A1
(43) Pub. Date: Aug. 9, 2007

(54) Method of a USB interface device with a discrimination function

(75) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(73) Assignee: Power Data Communications Co., Ltd. & Chien-Yuan CHEN

(21) Appl. No.: 11/346,361

(22) Filed: Feb. 3, 2006

(51) Int. Cl. G06K 19/06; G06K 5/00

(52) U.S. Cl. 235/492; 235/380; 235/382

(57) ABSTRACT

A method of a USB interface device with a discrimination function includes a device which is installed with a smart card to perform a transmission in a contact or non-contact method through a connection interface, so as to allow a user to input a fingerprint for comparison and validation. The device for inputting the user fingerprints is a hardware which uses the USB connection interface and which can replace a credit card for comparing permissions with a database, so as to discriminate a transmission of transaction data with a secure protocol. The fingerprint discrimination is provided with a function of one-time recording which cannot be changed, so as to assure a correctness of user transaction to serve as an essential factor of an activation key, and to prevent from plagiarizing, subrogating, and missing. In addition, the fingerprint data can be even archived for tracking.

### BACKGROUND OF THE INVENTION

(a) Field of the Invention

The present invention relates to a method of a USB (Universal Serial Bus) interface device with a discrimination function, and more particularly to a fingerprint discrimination device and a method of comparison and validation, so as to assure a privacy of user information.

(b) Description of the Prior Art

Internet is an indispensable tool in the current society; people use a feature that the internet has no boundary to shorten a distance between each other and to expand limitless business opportunity. Therefore, to proceed with transactions in the world of internet is also becoming more popular.

However, there are pros and cons for the internet. In the world of internet transactions, information can be leaked out or account can be plagiarized without a comprehensive information security or a monitoring of authentication; therefore, people are distrustfully questioning about the internet transactions.

Accordingly, the most important factors in proceeding with transactions on the internet are the authentication and secure protocol of information. If there is no comprehensive control mechanism or authentication, it will be a great potential risk, especially to the order of financial transactions.

A use of connection port (such as a COM (communication) port or a print port) in the market as a practice of controlling permissions of software usage (key protector) belongs to an early technology, which is only limited to a single function of specifying the permissions or the expiring time of software usage.

On the other hand, a USB (Universal-Serial-Bus) connector is a popular serial bus used in current data transmission; this specification is used in many computers and peripheral equipment to serve as an interface of transmission connector. Its advantage lies in that computer peripheral equipment of various specifications can be connected to a computer with a same connector, which replaces a previous shortcoming of using a single connector for single equipment. Accordingly, the application of recent development of USB connection interface is countless; for example, plug and play devices like a card reader, a portable disk, or a charger of cellular phone, are all an extended application using a feature that the USB transmission can be directly connected to the computer. However, the present invention is to provide the USB connector with a smart card communication interface which integrates a fingerprint discrimination device, to discriminate a transmission of user transaction information with a secure protocol. In addition, the discrimination of fingerprint is provided with a function of one-time recording, which can be assured to serve as an activation key for the user transaction.

### SUMMARY OF THE INVENTION

Accordingly, the primary object of present invention is to provide a method of USB interface device with a discrimination function, wherein the device is installed with a smart card to proceed with a contact-type or non-contact-type transmission through a connection interface to allow a user to input a fingerprint for comparison and validation, so as to provide a hardware device utilizing the USB connector with a function of fingerprint discrimination, thereby assuring a correct user transaction with a secure protocol to serve as an essential factor of activating a key, through the fingerprint discrimination device.

Another object of the present invention is to combine a smart card with a USB, such that a function of contact-type smart card can be exported through the USB interface, while a non-contact-type smart card can be communicated with external products through a wireless antenna.

Yet another object of the present invention is to provide a control of validation of permissions allowed between a user and a database, such that the user can access the database only after being validated on comparison.

Still another object of the present invention is to enable the fingerprints to be archived by requesting parties in countries or areas which approve the archiving of fingerprints, whereas to enable the fingerprints to be directly emplaced in a USB driver for countries or areas which do not approve the archiving of fingerprints.

Still another object of the present invention is to archive the fingerprints of plagiarizers to facilitate tracking.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a USB interface device with a discrimination function of the present invention.

FIG. 2 shows a schematic view of signal connection of a USB interface device with a discrimination function of the present invention.

FIG. 3 shows a flow diagram of transaction discrimination of a USB interface device with a discrimination function of the present invention.

### DETAILED DESCRIPTION OF THE PREFERRED EMBODIMENTS

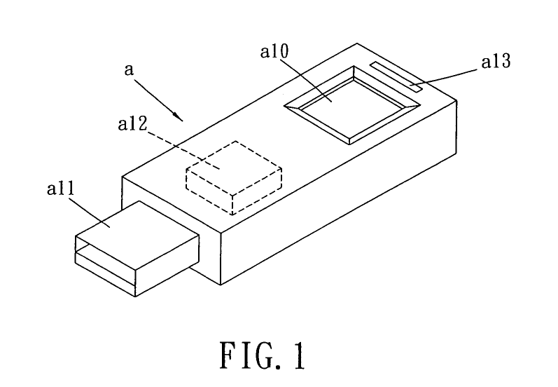

Referring to FIG. 1, a computer peripheral hardware device a comprises at least a USB connection interface all, an antenna device a12, an expansion slot a13, and a fingerprint input interface a10. As the USB is provided with the following characteristics that:

1. It is provided with an extraordinary capability of expansion, which can be serially connected with tens of peripheral equipment, and can have a smaller size due to a design of expansion slot;

2. All serially connected USB devices occupy only one set of same system resource (IRQ—Interrupt Requests, DMA—Direct Memory Access, and I/O address);

3. USB 2.0 is provided with a 480 Mb/s of high speed transmission capability;

4. A mainframe can supply required power to peripheral equipment through the USB interface; and

5. It supports functions of hot swapping and plug-and-play (PnP);

it is used as a best embodiment of the present invention.

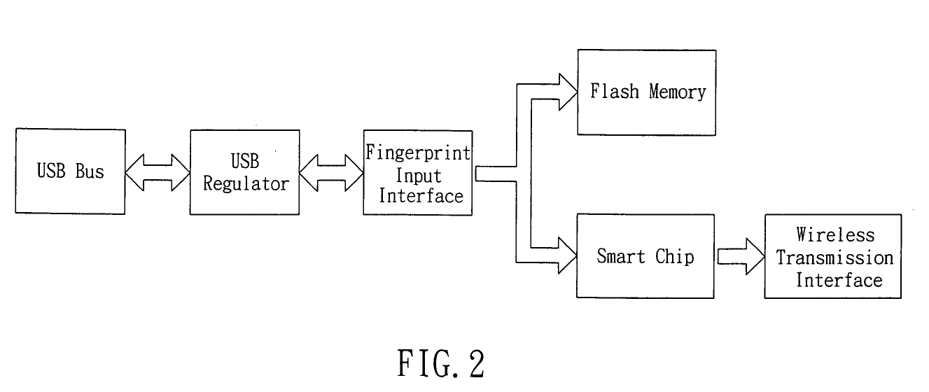

Referring to FIG. 2, it shows a signal connection procedure of the computer peripheral hardware device a of the present invention. A USB regulator retrieves signal data of a fingerprint input interface from a flash memory and transmits it to a wireless transmission interface through a smart chip, or connects it with a mainframe directly through a USB bus.

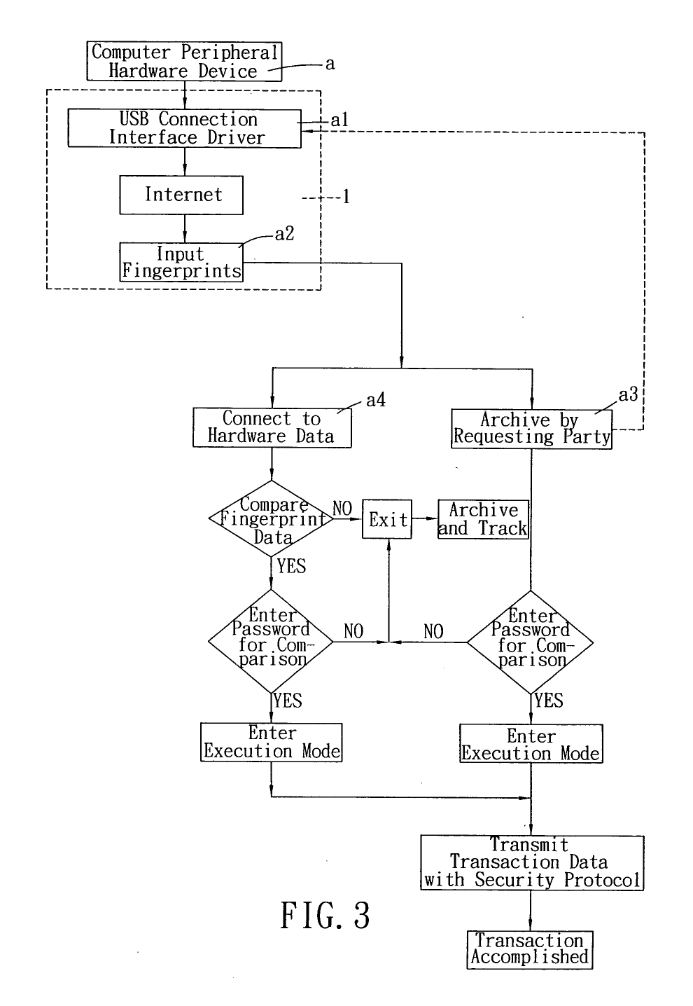

Referring to FIG. 3, it shows a flow diagram of transaction discrimination of the present invention. The present invention is connected to the internet, wherein software to be used should first be installed in a mainframe 1 to stay in a resident status and to be activated while booting up the mainframe 1. The software can actively detect whether a USB connection port is connected to the computer peripheral hardware device a of fingerprint discrimination device of the present invention. If a device is detected, a next step will be executed. On the contrary, if the software cannot detect that device, it will stop running or prohibit an authentication of transaction.

After the connection of computer peripheral hardware device a is detected, a fingerprint input mode a2 will be entered. As each country or area has a different regulation on archiving the fingerprints, so will be the authentication step. If the archiving is approved, then the next step will be archiving by requesting parties a3. On the contrary, if the archiving is not approved, then the next step will be a direct connection to hardware data a4 wherein data is only connected to a USB driver. Under the condition that fingerprints archiving is approved, the fingerprints are archived according to permissions configured at a controlling mainframe, followed by writing the authentication data into a USB driver a1 of the computer peripheral hardware device a, and by entering into a mode for inputting a password for comparison in the same time. If a result of password comparison is correct, an execution mode will be entered; whereas if the result of password comparison is incorrect, the procedure will be exited. In the same time, management functions of expiring time of preservation and a number of usages of the fingerprint data can be configured in the USB driver a1.

After entering the execution mode, a transmission of transaction data with a secure protocol can be proceeded through comparing a correctness of fingerprint discrimination data, thereby accomplishing the transaction. The aforementioned are the authentication procedure and the control mechanism for the situation that the archiving of fingerprints is approved.

On the other hand, if the archiving of fingerprints is not approved, then the connection to hardware data a4 will be proceeded to validate the input fingerprints a2, followed by comparing the fingerprints data. If a result of fingerprint comparison is correct, a password is entered for comparison. On the contrary, if the result of fingerprint comparison is incorrect, the procedure will be exited and the incorrect fingerprints will be archived to facilitate tracking. When the password is entered for comparison, the mode of password comparison will be entered. If a result of password comparison is correct, then the execution mode is entered; whereas if the result of password comparison is incorrect, the procedure will be exited. After entering the execution mode, a transmission of transaction data with a secure protocol can be proceeded through comparing the correctness of fingerprint discrimination data, thereby accomplishing the transaction. This is the authentication and control procedure for the situation that the archiving of fingerprints is not approved.

Of the methods used in present invention for connecting to a computer 1, a USB connection interface is a best embodiment for the computer peripheral hardware device a, whereas the rest can be a printer port, a COM port, an IEEE 1394 interface, a RJ45 215 interface, and an infrared transmission interface. The primary object of the interface is to connect the computer peripheral hardware device a and the mainframe 1 to the internet and to access and manage a configuration of user permissions in a database.

Accordingly, if a detection result shows that the computer peripheral hardware device a is permitted to use the functions of internet, then different situations will arise according to conditions to be used:

(1) Effectively Managing the User Permissions:

A website location (IP) of limited access is stored in the computer peripheral hardware device a. When a user is to access the website while using the internet, a checking by the computer peripheral hardware device a should be first performed. At this time, application software will require the fingerprints a2 to be input, and can only open a connection to the database after validating the fingerprints. In the mean time, a manager can edit or change the permissions of password in the application software at all time, to effectively control the utilization of password and permissions.

(2) Assuring Data Security One-Time for a One-User-One-Machine Mode:

The computer peripheral hardware device a is operated in a one-user-one-machine mode and needs to enter the fingerprints a2 only once to actively store user information into the database. Therefore, when the user is to use the internet transactions, the input fingerprints a2 should be first discriminated through the computer peripheral hardware device a, and the transaction mode can only be provided to the user after validating, thereby assuring a better uniqueness of the personalized computer peripheral hardware device a.

In the present invention, a hardware using the USB connection interface, such as a memory card, can be used to replace a credit card for non-contact-type connection to the database, to proceed with a comparison of permissions, thereby discriminating a transmission of user transaction information with a secure protocol. For countries or areas which approve an archiving of fingerprints, as the fingerprint has a uniqueness and privacy of individual, a one-time recording can serve as a control mechanism and the fingerprints can be an essential factor in validating the transactions through the archiving procedure, upon archiving the fingerprint discrimination data. On the other hand, for countries or areas which do not approve the archiving of fingerprints, the memory card can be used to replace the credit card for non-contact-type connection to the database, to serve as a final validation for every transaction; that it, the validation is through the fingerprint discrimination in performing the non-contact-type functions.

Another characteristic of the present invention is that in comparing the fingerprints, the incorrect fingerprints are archived to facilitate a tracking of plagiarizers, which will contribute to a criminal prevention.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A method of a USB interface device with a discrimination function, wherein the device is installed with a smart card which performs a transmission in a contact or non-contact method through a connection interface to allow a user to input a fingerprint for comparison and validation, so as to assure a privacy of user information and to archive fingerprints of plagiarizers for tracking, and which comprises a computer peripheral hardware device installed with a connection interface and a fingerprint input interface, wherein the connection interface is connected to a mainframe for providing a connection to the internet and a data comparison with a database, whereas the fingerprint input interface provides a user to input the fingerprint.

2. The method of a USB interface device with a discrimination function according to claim 1, wherein the fingerprint discrimination is only provided with a function of one-time recording which cannot be changed, such that the established fingerprint discrimination data can assure a correctness of user transaction and thus serving as an essential factor of activation or validation.

3. The method of a USB interface device with a discrimination function according to claim 1, wherein the contact-type smart card is exported through the USB interface, whereas the non-contact-type smart card is performing a communication through a wireless device.

4. The method of a USB interface device with a discrimination function according to claim 1, wherein a USB connection interface is a best embodiment for the connection interface.

5. The method of a USB interface device with a discrimination function according to claim 1, which is provided with a personal data and a password that can be combined with a data at network end, thereby forming a special data management to prevent from plagiarizing, subrogating, and missing.

6. The method of a USB interface device with a discrimination function according to claim 1, wherein the USB connection interface is provided with a communication interface or a function of smart card.

7. The method of a USB interface device with a discrimination function according to claim 1, wherein the USB connector can also be a printer port, a COM port, an IEEE 1394 interface, a RJ45 215 interface, and an infrared transmission interface.

8. The method of a USB interface device with a discrimination function according to claim 3, wherein the USB connector can also be a printer port, a COM port, an IEEE 1394 interface, a RJ45 215 interface, and an infrared transmission interface.

9. A method of a USB interface device with a discrimination function, wherein the fingerprint input mode can discriminate an original user from a plagiarizer.

10. The method of a USB interface device with a discrimination function according to claim 1, wherein in countries or areas which approve an archiving of fingerprints, the user fingerprints are archived according to permissions configured at a controlling mainframe, followed by writing the authentication data into the computer peripheral hardware device, and by entering into a mode for entering a password for comparison in the same time; an execution mode being entered on a correct password comparison, whereas the procedure being exited on an incorrect password comparison; a transmission of transaction data with a secure protocol being able to be proceeded through a correct comparison of fingerprint discrimination data, after entering the execution mode, thereby accomplishing the transaction.

11. The method of a USB interface device with a discrimination function according to claim 1, wherein in countries or areas which do not approve an archiving of fingerprints, the hardware data can be directly connected to validate and compare the input fingerprints; a password being entered for comparison on a correct fingerprint comparison, whereas the procedure being exited and the incorrect fingerprints being archived to facilitate tracking on an incorrect fingerprint comparison; when the password being entered for comparison, the mode of password comparison being entered and the execution mode being entered on a correct password comparison, whereas the procedure being exited on an incorrect password comparison; a transmission of transaction data with a secure protocol being able to be proceeded through comparing the correctness of fingerprint discrimination data, after successfully entering the execution mode, thereby accomplishing the transaction.

12. The method of a USB interface device with a discrimination function according to claim 1, wherein management functions of expiring time of preservation and a number of usages of the fingerprint data can be configured into a driver of connection interface.

13. The method of a USB interface device with a discrimination function according to claim 1, wherein the connection interface can be fitted with an expansion slot.

14. The method of a USB interface device with a discrimination function according to claim 1, wherein the non-contact-type functions are performed through a validation of fingerprint discrimination data.

15. The method of a USB interface device with a discrimination function according to claim 3, wherein the non-contact-type functions are performed through a validation of fingerprint discrimination data.
